(19) United States
(12) Patent Application Publication
(10) Pub. No.: US 2008/0244406 A1
(43) Pub. Date: Oct. 2, 2008

(54) CAMERA APPARATUS AND GUI SWITCHING METHOD IN CAMERA APPARATUS

(75) Inventors: Tatsuhiko IKEHATA, Tokyo (JP); Tatsuro ABE, Tokyo (JP); Toyokazu AIZAWA, Tokyo (JP); Shiro NAGAOKA, Tokyo (JP)

Correspondence Address: PILLSBURY WINTHROP SHAW PITTMAN, LLP, P.O. BOX 10500, MCLEAN, VA, 22102, US

(73) Assignee: Kabushiki Kaisha Toshiba, Tokyo (JP)

(21) Appl. No.: 12/056,826

(22) Filed: Mar. 27, 2008

(30) Foreign Application Priority Data
Mar. 30, 2007 (JP) 2007-090387

(51) Int. Cl. G06F 3/00

(52) U.S. Cl. 715/718

(57) ABSTRACT

According to one embodiment, a camera apparatus has a display device displaying an image data and a GUI switching unit switching between a GUI (Graphical User Interface) displayed by the display device and a GUI (Graphical User Interface) displayed by an external display device.

### CROSS-REFERENCE TO RELATED APPLICATIONS

This application is based upon and claims the benefit of priority from Japanese Patent Application No. 2007-90387, filed Mar. 30, 2007, the entire contents of which are incorporated herein by reference.

### BACKGROUND

1. Field

One embodiment of the invention relates to a camera apparatus, such as a digital camera, a vide camera or the like, and a GUI switching method in the camera apparatus.

2. Description of the Related Art

Conventionally, there is a known camera apparatus (also called an electronic camera apparatus) that captures an optical image of a subject as a still image or a moving image, converts the shot image into image data, and electronically saves it. Conventional camera apparatuses include a digital camera mainly shooting the still image and a video camera mainly shooting the moving image.

Various types of both digital camera and video camera have been conventionally widely used. For instance, Japanese Patent Application Publication (KOKAI) No. 2004-128587 (Patent Document 1) discloses a digital camera that detect-s the display resolution of the external display device when it is connected thereto, enlarges or reduces the image for display according to the detected display resolution and displays the resulting image.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary perspective view showing an appearance seen from the rear side of a camera apparatus according to an embodiment of the invention;

FIG. 2 is an exemplary block diagram showing a main configuration of the same camera apparatus in the embodiment;

FIG. 3 is an exemplary flowchart showing an operation procedure of GUI display control processing in the embodiment;

FIG. 4 is an exemplary flowchart showing an operation procedure of GUI display processing in the embodiment;

FIGS. 5(a) and 5(b) are exemplary views showing examples of GUI displays, FIG. 5(a) being a case when displayed on an LCD, and FIG. 5(b) being a case when displayed on an external monitor in the embodiment;

FIGS. 6(a) and 6(b) are exemplary views showing other examples of the GUI displays, FIG. 6(a) being a case when displayed on the LCD, and FIG. 6(b) being a case when displayed on the external monitor in the embodiment; and

FIG. 7 is an exemplary flowchart showing an operation procedure of other GUI display control processing in the embodiment.

### DETAILED DESCRIPTION

Various embodiments according to the invention will be described hereinafter with reference to the accompanying drawings. In general, according to one embodiment of the invention, a camera apparatus includes a display device displaying an image data and a GUI switching unit switching between a GUI (Graphical User Interface) displayed by the display device and a GUI (Graphical User Interface) displayed by an external display device.

Further, a GUI switching method in a camera apparatus including a display device displaying an image data is performed as follows. That is, the method sets any one of a first display parameter for causing the display device to display a GUI (Graphical User Interface) adapted to the display device and a second display parameter for causing an external display device to display a GUI (Graphical User Interface) adapted to the external display device, and switches between the GUI (Graphical User Interface) displayed by the display device and the GUI (Graphical User Interface) displayed by the external display device, according to the set first display parameter or second display parameter.

(Configuration of Camera Apparatus)

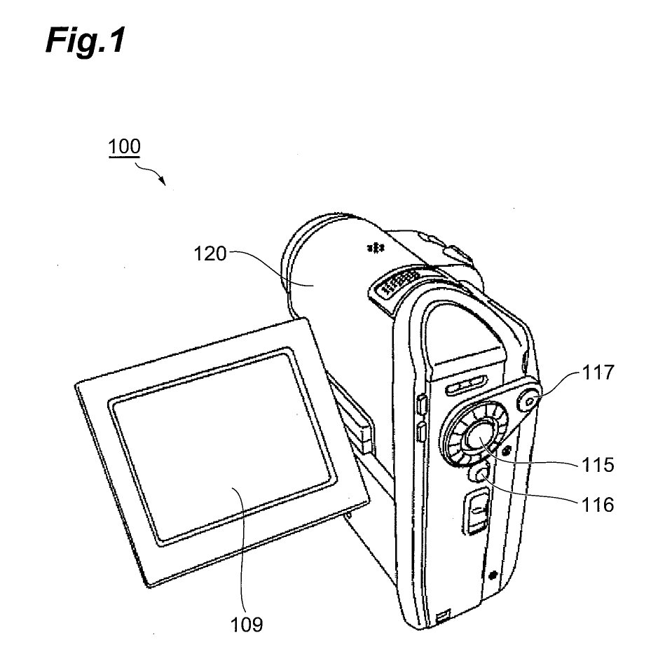

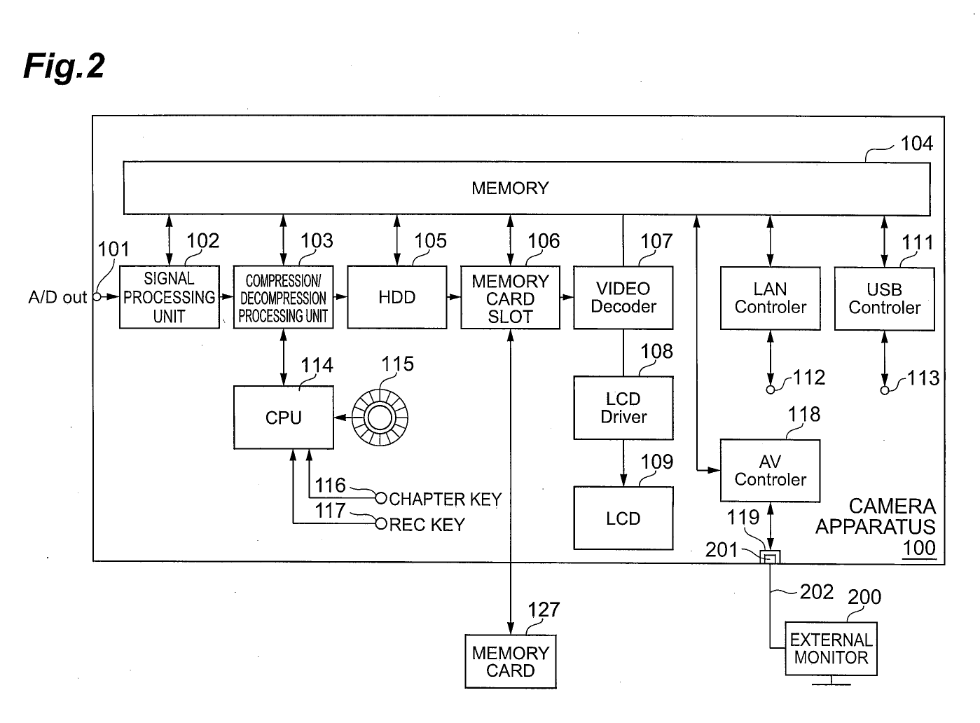

FIG. 1 is a perspective view showing an appearance seen from the rear side of a camera apparatus 100 according to an embodiment of the present invention, FIG. 2 is a block diagram showing a main configuration of the same camera apparatus 100. The camera apparatus 100 shown in FIG. 1 and FIG. 2 is a digital video camera apparatus capable of shooting mainly moving images and also still images.

The camera apparatus 100 incorporates various kinds of electronic components such as CCDs (Charge Coupled Devices) and has a main body 120 with later-described various kinds of operation keys and an LCD display 109. The LCD display 109 is movably attached to a side surface portion of the main body 120. The LCD display 109 is a display device that displays the image data.

The camera apparatus 100 handles data compressed in compliance with MPEG-2 when shooting and reproducing the moving image. When reproducing a moving image, the camera apparatus 100 can easily realize trick reproduction such as reverse reproduction, high-speed reproduction, high-speed reverse reproduction, frame forward, and frame rewind, in addition to normal reproduction. Further, unlike a case in which a magnetic tape is employed as an image data recording medium, a random-accessible recording medium such as a later-described HDD 105 or a memory card 127 is employed in the camera apparatus 100. This allows a user to easily search a video that the user wants to watch.

As shown in FIG. 2, the camera apparatus 100 includes a digital signal output unit 101, a signal processing unit 102, a compression/decompression processing unit 103, a memory 104, and the HDD (Hard Disk Drive) 105.

The camera apparatus 100 also includes a memory card slot 106, a video decoder 107, an LCD (Liquid Crystal Display) driver 108, an LCD 109, a LAN controller 110, and a USB controller 111. Furthermore, the camera apparatus 100 includes a LAN terminal 112, a USB terminal 113, a CPU 114, an operation device 115, and two operation keys (a chapter key 116 and a REC key 117), and further includes an AV controller 118 and an AV terminal connecting unit 119.

The digital signal output unit 101 converts an analog electric signal, which is generated by a CCD (Charge Coupled Device) using an optical image of a subject obtained through a not-shown lens, into a digital signal and outputs the digital signal to the signal processing unit 102.

The signal processing unit 102 has a function as a moving image data generating unit that performs image processing on the inputted digital signal to generate moving image data indicating an image data that has been actually shot. Note that the generated moving image data is once stored in the memory 104.

The compression/decompression processing unit 103 compresses the moving image data exported from the memory 104 in compliance with MPEG-2 to produce compressed moving image data, and compresses still image data in compliance with JPEG to produce compressed still image data. Further, following an instruction of the CPU 114, the compression/decompression processing unit 103 decompresses the compressed moving image data and the compressed still image data.

The memory 104 temporarily stores data to be processed by the signal processing unit 102, and data to be processed by the compression/decompression processing unit 103.

The HDD 105 is an external memory device that records the moving image data which has been compressed (compressed moving image data), sound data which has been compressed, and the compressed still image data to an HD (Hard Disc) incorporated therein. The HDD 105 reads/writes data from/to the HD (Hard Disc) on a random access basis.

The memory card slot 106, into which the memory card 127 such as an SD memory card (Secure Digital memory card) is inserted, reads/writes data from/to the inserted memory card 127. In the memory card 127, the compressed moving image data and the like is recorded.

In order to display the image data using the compressed moving image data, the video decoder 107 performs a decoding process on the moving image data and outputs the resulting data to the LCD driver 108 and the AV controller 118. The video decoder 107 is a software decoder realized with a decoding program.

The LCD driver 108 converts the decoded moving image data received from the video decoder 107 into a display signal compatible with an interface of the LCD 109. The LCD 109 displays the image data using the display signal outputted from the LCD driver 108. Further, the LCD 109 displays GUI in response to the operation by the user.

Following the instruction of the CPU 114, the LAN controller 110 transfers the moving image data exported from the memory 104 to a not-shown external apparatus (for example, a DVD recorder or an HDD recorder) connected via the LAN terminal 112. Besides, the LAN controller 110 outputs to the memory 104 the moving image data imported from the external apparatus via the LAN terminal 112.

Following the instruction of the CPU 114, the USB controller 111 transfers the moving image data exported from the memory 104 to a not-shown external apparatus (for example, a personal computer) connected via the USB terminal 113. Besides, the USB controller 111 outputs to the memory 104 the moving image data imported from the external apparatus via the USB terminal 113.

Following a program stored in a not-shown ROM, the CPU 114 operates as various units (a GUI switching unit, a parameter setting unit, a connection judging unit, an acquiring unit, and a display judging unit). Further, the CPU 114 inputs/outputs a signal into/from the other components to control the entire operation of the camera apparatus 100 and the respective sequences.

The operation device 115 includes a JOG dial and a cross key. The operation device 115 is an operation device operated by a user to select and execute various functions (for example, stop and start of reproduction, stop and pause of shooting, and the like) in the camera apparatus 100. Further, when the JOG dial is operated during reproduction of the moving image, the reproduction speed is adjusted in accordance with the operation.

The chapter key 116 inputs a chapter generating instruction to the CPU 114 according to a pressing operation by the user. The chapter generating instruction is data instructing the CPU 114 to generate chapter data and record the generated chapter data to a chapter table. Note that the use of the chapter key 116 allows the chapter data to be generated by manual operation by the user. The REC key 117 inputs an instruction to start video-recording to the CPU 114 according to a pressing operation by the user.

Following the instruction of the CPU 114, the AV controller 118 outputs the moving image data exported from the memory 104 to an external monitor 200 connected via the AV terminal 119 and an AV cable 202 to cause the external monitor 200 to display the moving image. Following the instruction of the CPU 114, the AV controller 118 also causes the LCD 109 to display a GUI according to a later-described first or second display parameter. Further, following the instruction of the CPU 114, the AV controller 118 executes communication to/from the external monitor 200.

The AV terminal 119 is configured such that a connector 201 of the AV cable 202 is inserted thereinto. To this AV terminal 119, a cable provided with any of a composite terminal, an S terminal, a component terminal, a D terminal and an HDMI terminal opposite the connector 201 can be connected as the AV cable 202. The AV cable 202 is configured such that the external monitor 200 is connected to the side opposite the connector 201.

Further, the camera apparatus 100 is configured to judge whether the external monitor 200 is a display device capable of performing display with high resolution (high resolution display) (referred to also as a high resolution display device) based on the shape of the terminal of the AV cable 202 connected to the AV terminal 119 (described later in detail).

(Operation Details of Camera Apparatus)

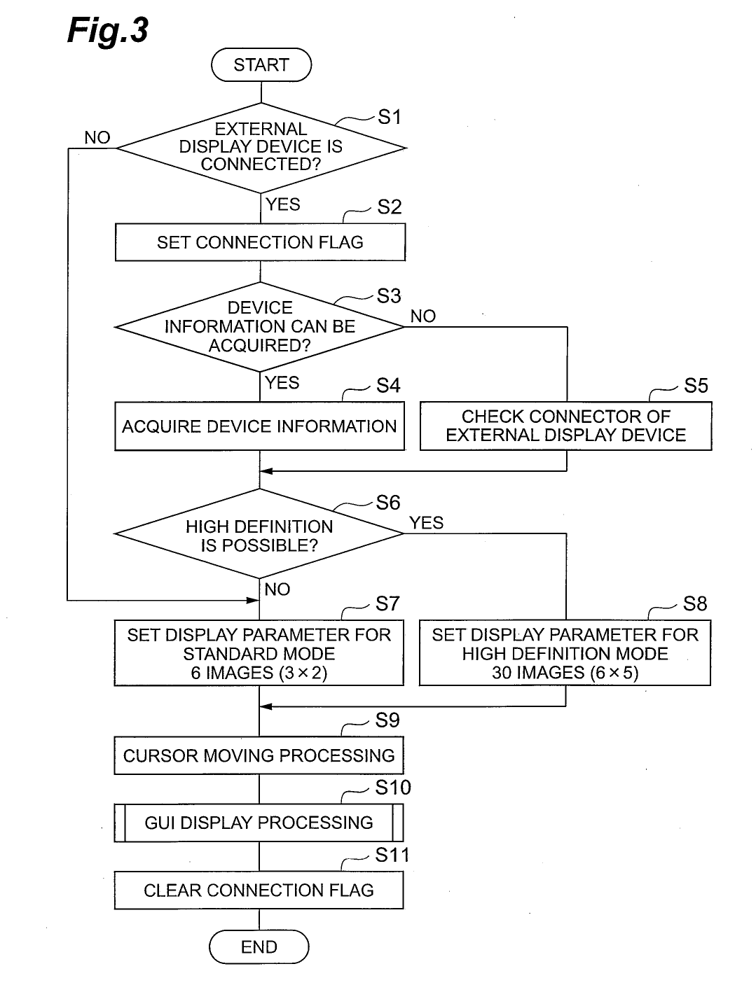

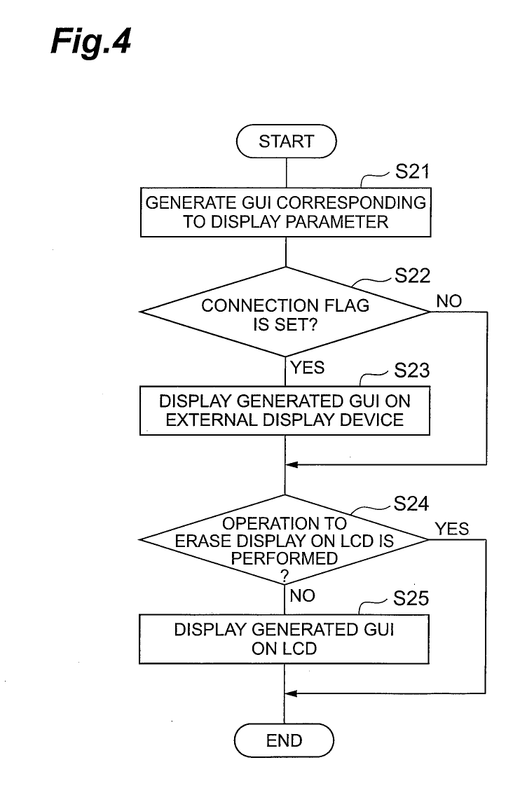

Next, operation details of the camera apparatus 100 will be described with reference to FIG. 3 to FIG. 4. FIG. 3 is a flowchart showing an operation procedure of GUI display control processing, and FIG. 4 is a flowchart showing an operation procedure of GUI display processing.

The camera apparatus 100 executes the GUI display control processing following the flowchart shown in FIG. 3 when an operation input of the user using the operation device 115 is presented and it is necessary to display a GUI (Graphical User Interface) corresponding to the operation input on the LCD 109 or the external monitor 200. The GUI display control processing is executed by the CPU 114 following the flowchart shown in FIG. 3.

After starting the GUI display control processing, the CPU 114 performs an operation as the connection judging unit to judge whether the external monitor 200 as the external display device is connected (S1).

When the CPU 114 judges that the external monitor 200 is connected, it sets data indicating that the external monitor 200 is connected (which is, for example, “1” in this embodiment, and other data may be employed) in a connection flag (S2). Besides, when the CPU 114 does not judge that the external monitor 200 is connected, it proceeds to later-described S7.

The CPU 114 proceeds to S3 subsequent to S2 to judge whether later-described device information can be acquired from the external monitor 200 by communication with the external monitor 200. The CPU 114 proceeds to later-described S4 when it judges that the device information can be acquired, and otherwise it proceeds to later-described S5.

The CPU 114 proceeding to S4 performs an operation as the acquiring unit to instruct the AV controller 118 to perform communication with the external monitor 200 so as to acquire the device information from the external monitor 200 under control of the AV controller 118 (S4). On the other hand, the CPU 114 proceeding to S5 records information (connector information) for checking the kind of the connector of the AV cable 202 connected to the AV terminal 119.

The CPU 114 proceeds to S6 subsequent to S4 or S5 and performs an operation as the display judging unit to judge whether the external monitor 200 is a high resolution display device based on the device information or the connector information (S6).

The CPU proceeds to S8 when it judges that the external monitor 200 is a high resolution display device, and otherwise proceeds to S7. When judging here depending on the connector information in S6, the CPU 114 can judge as follows. For example, when the kind of the connector is the D terminal or the HDMI terminal, the CPU 114 can judge that the external monitor 200 is a high resolution display device, and otherwise it can judge that the external monitor 200 is not a high resolution display device.

In the above manner, the camera apparatus 100 sets a later-described first display parameter both in the case when the external monitor 200 is not connected and in the case when the connected external monitor 200 is a device incapable of display with high resolution. The camera apparatus 100 is also configured to set a later-described second display parameter when an external monitor 200 is connected thereto and the external monitor 200 is a device capable of display with high resolution.

Since the GUI is generated according to the set display parameter (later-described S21), the CPU 114 switches between GUIs by changing the display parameter to be set according to whether the external monitor 200 is connected. Thus, the CPU 114 performs an operation as the GUI switching unit.

Further, the CPU 114 proceeding to S7 sets a display parameter for a standard definition mode (a display parameter mainly for the LCD 109, referred also to as the first display parameter), whereas the CPU 114 proceeding to S8 sets a display parameter for a high definition mode (a display parameter for the external monitor 200 capable of high resolution display, referred also to as the second display parameter). Note that the CPU 114 operates as the parameter setting unit in S7 and S8.

The display parameter here can be composed of a GUI map with coordinate data indicating the display position of each item of a GUI to be displayed.

Further, the CPU 114 proceeds to S9 subsequent to S7 or S8 and performs cursor moving processing in response to an operation input at the operation device 115, and performs later-described GUI display processing in subsequent S10 to cause one or both of the LCD 109 and the external monitor 200 to display the GUI.

The CPU 114 executes the GUI display processing and then clears the connection flag (S11) to end the GUI display control processing.

The CPU 114 then executes the GUI display processing following the flowchart shown in FIG. 4.

After starting the GUI display processing, the CPU 114 generates a GUI corresponding to the set display parameter (S21). Subsequently, the CPU 114 judges whether the connection flag is set (whether the connection flag is “1”) (S22). The CPU 114 here executes S23 when it judges that the connection flag is set (the external monitor 200 is connected in this case), and otherwise the CPU 114 proceeds to S24 without executing S23.

The CPU 114 proceeding to S23 instructs the AV controller 118 to cause the external monitor 200 to display the generated GUI.

The CPU 11 proceeding to S24 judges whether the operation to erase the display of the GUI on the LCD 109 (a display erasing operation) has been performed by the user through the operation input from the operation device 115.

When the CPU 114 judges that the display erasing operation has been performed, it ends the GUI display processing without executing later-described S25. On the other hand, when the CPU 114 does not judge that the display erasing operation has been performed, it proceeds to S25.

The CPU 114 proceeding to S25 instructs the LCD driver 108 to cause the LCD 109 to display the generated GUI. After executing S25, the CPU 114 ends the GUI display processing.

In the above-described GUI display control processing, the CPU 114 can set here the display parameter for the standard definition mode (the first display parameter) and the display parameter for the high definition mode (the second display parameter) as follows.

For example, the display parameter in the case of displaying the GUI for thumbnail display of the image data can be set as follows by the operation input of the user.

For example, the display parameter for the standard definition mode is set such that 6 thumbnails in total in 2 rows and 3 columns are displayed. Further, the display parameter for the high definition mode is set such that 30 thumbnails in total in 5 rows and 6 columns are displayed to present five times of thumbnails.

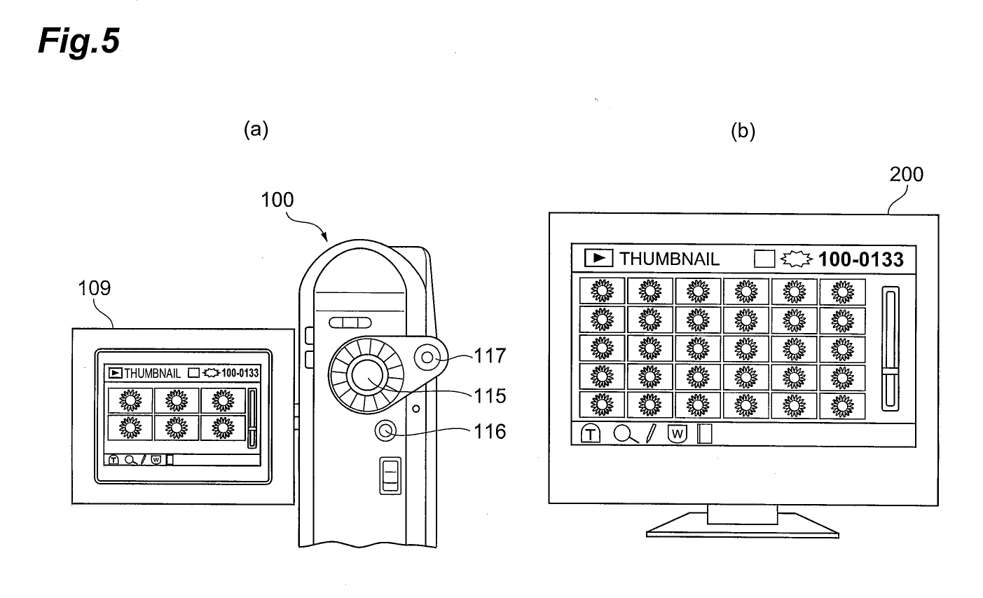

This ensures that the number of displayed thumbnails (each thumbnail is the displayed item in this case) is decreased according to the magnitude of the screen size to thereby enlarge each thumbnail so that the GUI can be displayed on the LCD 109 with the thumbnails easily viewed as shown on the left side in FIG. 5.

When the external monitor 200 is a device capable of display with high resolution, the GUI can be displayed such that the number of displayed thumbnails is increased according to the magnitude of the screen size as shown on the right side in FIG. 5.

The camera apparatus 100 can switch between the GUIs depending on the display device, whereby for display on the LCD 109, the number of displayed items can be made relatively small to present an easily viewable display attaching importance to viewability in spite of its small screen size. Besides, when the external monitor 200 is connected, the number of displayed items can be made large to adapt to its screen size to thereby display information as much as possible. Accordingly, the camera apparatus 100 is configured to be able to perform displays adapted to display performances of the LCD 109 and the external monitor 200.

The above configuration can enhance the listing property of the GUI display when the external monitor 200 is connected to also increase the convenience when the user retrieves necessary information.

In addition, the camera apparatus 100 sets the display parameters respectively according to the LCD 109 and the external monitor 200, and displays GUIs according to the set display parameters. Thus, the processing can be further simplified than the case of separately generating the GUIs respectively corresponding to the LCD 109 and the external monitor 200. Further, the GUI can be changed by flexible response such as change of display parameter, so that even if necessity to change the GUI arises, it is easily addressed.

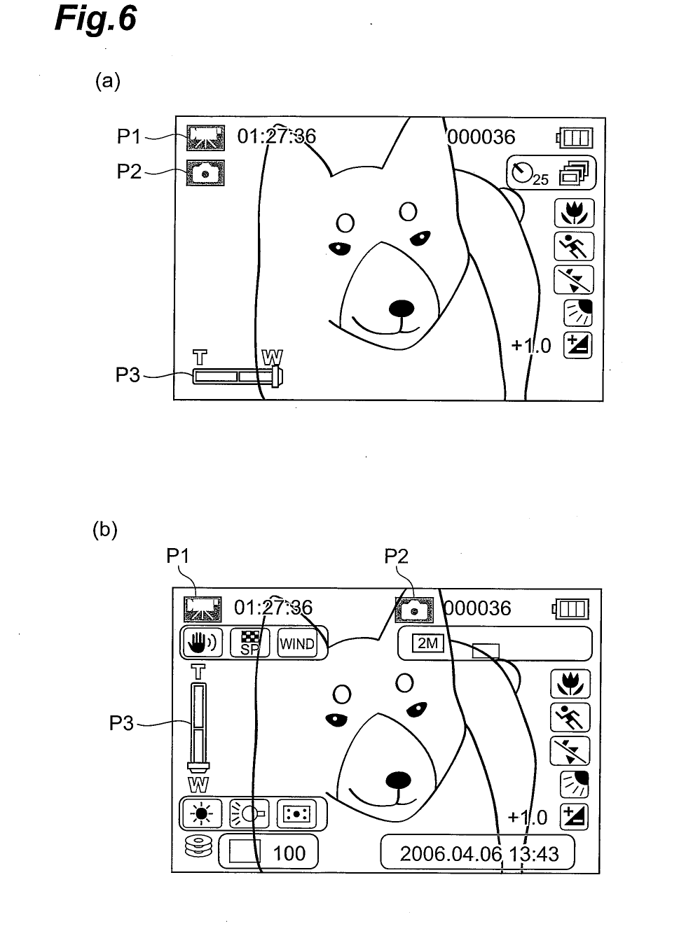

The camera apparatus 100 can also display the GUIs as shown in FIGS. 6(A) and 6(B) by changing the setting of the display parameter. FIG. 6(A) is a view showing another example of the GUI displayed on the LCD 109, and FIG. 6(B) is a view showing another example of the GUI display on the external monitor 200. As shown in FIGS. 6(A) and 6(B), the GUI displayed on the TCD 109 and the GUI display on the external monitor 200 may be switched such that not only a difference is made in the number of displayed items but also the arrangement locations of the displayed items are changed or the design is changed.

In contrast to FIG. 6(A) in which a moving image mark P1 and a still image mark P2 are displayed vertically arranged on the left side, the moving image mark P1 and the still image mark P2 are separately displayed on the right and left sides in FIG. 6(B).

Further, in contrast to FIG. 6(A) in which a zoom bar P3 is displayed in a lateral direction and alone without other items on the lower side in the screen, the zoom bar P3 is displayed longitudinally together with other items on the left side in the screen in FIG. 6(B).

Switching between the GUIs according to whether the device displaying the image data and the GUI is the LCD 109 or the external monitor 200 as in FIGS. 6(A) and 6(B) enables a manner to display not only the amount of information to be displayed but also the GUI in a sharp and easily viewable design on the LCD 109, while the GUI in a cool design on the external monitor 200.

The camera apparatus 100 is likely to be used outdoors and the external monitor 200 is rarely connected to the camera apparatus 100 when it is used outdoors so that the device displaying the shot image and the GUI is often only the LCD 109. Thus, displaying the GUI in a sharp and easily viewable design on the LCD 109 allows the LCD 109 to fully exhibit its display performance even outdoors.

Further, even when the external monitor 200 is connected to the camera apparatus 100, the display parameter for the high definition mode is set only when the external monitor 200 is a high resolution display device. Therefore, even if the external monitor 200 is connected, the GUI is displayed with the same standard resolution as that of the LCD 109, if the external monitor 200 is not capable of a high resolution display. Thus, the camera apparatus 100 can reflect a difference in resolution in the display of GUI to thereby perform a GUI display according to the display performance of the external monitor 200.

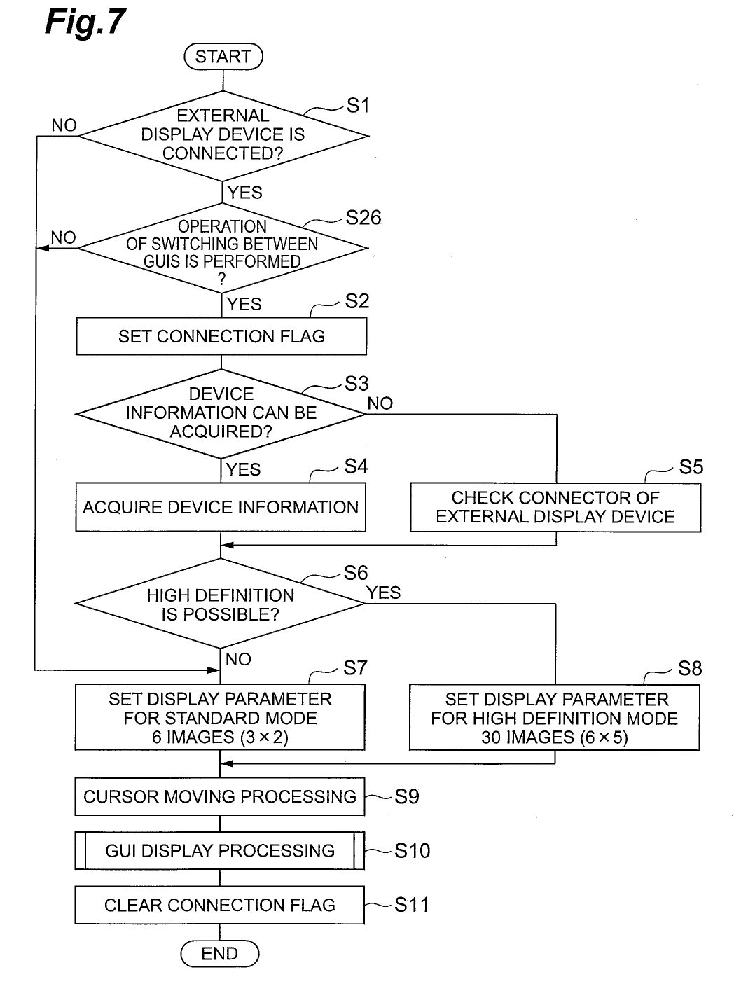

Incidentally, the camera apparatus 100 may be configured to manually switch the display of GUI. In this case, for example, the camera apparatus 100 can execute the GUI display control processing following a flowchart shown in FIG. 7.

This flowchart is different from the flowchart shown in FIG. 3 in that S26 is executed between S1 and S2 and the same in the remaining. In S26, the CPU 114 judges whether the operation of switching between the GUIs has been performed by the user.

When the CPU 114 judges that the operation of switching between the GUIs has been performed, it proceeds to S2, and otherwise it proceeds to S7.

The operation of switching between the GUIs here refers to an operation for the user to switch the GUI display from the LCD 109 to the external monitor 200 using the operation device 115. If the user manually performs the operation of switching between the GUIs when the external monitor 200 is connected to the camera apparatus 100, the processing proceeds to S2 in which the connection flag is set, whereas if the user does not manually perform the operation of switching between the GUIs, the connection flag is not set even if the external monitor 200 is connected. Therefore, whether the GUI display on the external monitor 200 is performed or not is switched depending on whether the user manually performs the operation of switching between the GUIs.

This also allows manual switching from the LCD 109 to the external monitor 200 for the camera apparatus 100.

Note that the above-described camera apparatus 100 has the HDD 105 as an external memory device capable of reading/writing data on a random access basis and may have a DVD drive that records data to a DVD (Digital Versatile Disk) in addition to the HDD 105. The camera apparatus 100 may be configured to store moving image data in a rewritable memory medium such as DVD-RW, DVD-RAM and the like by the DVD drive.

The description in the above is to describe the embodiments of the invention and, in no case, limits the apparatus and method of the invention, so that various modifications can be embodied with ease. Further, the apparatus and method structured by appropriately combining the components, the functions, the features or the steps of the method in the respective embodiments are also within the scope of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A camera apparatus comprising:
a display device displaying an image data; and
a GUI switching unit switching between a GUI (Graphical User Interface) displayed by said display device and a GUI (Graphical User Interface) displayed by an external display device.

2. The camera apparatus according to claim 1,
wherein said GUI switching unit switches between the GUI (Graphical User Interface) displayed by said display device and the GUI (Graphical User Interface) displayed by said external display device, depending on whether said external display device is connected.

3. The camera apparatus according to claim 1, further comprising:
a parameter setting unit setting any one of a first display parameter for causing said display device to display the GUI adapted to said display device and a second display parameter for causing said external display device to display the GUI adapted to said external display device,
wherein said GUI switching unit switches between the GUI (Graphical User Interface) displayed by said display device and the GUI (Graphical User Interface) displayed by said external display device, according to the first display parameter or the second display parameter set by said parameter setting unit.

4. The camera apparatus according to claim 3,
wherein said parameter setting unit sets the first display parameter so that the number of displayed items of the GUI (Graphical User Interface) displayed by said display device is smaller than that of the GUI (Graphical User Interface) displayed by said external display device.

5. The camera apparatus according to claim 3, further comprising:
a connection judging unit judging whether said external display device is connected;
an acquiring unit acquiring device information about a display performance of said external display device from said external display device when said connection judging unit judges that said external display device is connected; and
a display judging unit judging whether said external display device is capable of a high resolution display with a higher resolution than that of said display device, according to the device information acquired by said acquiring unit,
wherein said parameter setting unit sets the second display parameter for the high resolution display when said display judging unit judges that the high resolution display is possible.

6. The camera apparatus according to claim 4, further comprising:
a connection judging unit judging whether said external display device is connected;
an acquiring unit acquiring device information about a display performance of said external display device from said external display device when said connection judging unit judges that said external display device is connected; and
a display judging unit judging whether said external display device is capable of a high resolution display with a higher resolution than that of said display device, according to the device information acquired by said acquiring unit,
wherein said parameter setting unit sets the second display parameter for the high resolution display when said display judging unit judges that the high resolution display is possible.

7. The camera apparatus according to claim 5,
wherein said display judging unit judges whether said external display device is capable of the high resolution display, based on the kind of a connector for use in connection of said external display device.

8. The camera apparatus according to claim 5,
wherein said parameter setting unit sets the first display parameter or the second display parameter, according to a judgment result of said connection judging unit.

9. The camera apparatus according to claim 7,
wherein said parameter setting unit sets the first display parameter or the second display parameter, according to a judgment result of said connection judging unit.

10. A GUI switching method in a camera apparatus including a display device displaying an image data, said method comprising the steps of:
setting any one of a first display parameter for causing the display device to display a GUI (Graphical User Interface) adapted to the display device and a second display parameter for causing an external display device to display a GUI (Graphical User Interface) adapted to the external display device; and
switching between the GUI (Graphical User Interface) displayed by the display device and the GUI (Graphical User Interface) displayed by the external display device, according to the set first display parameter or second display parameter.
